(19) United States
(12) Patent Application Publication
(10) Pub. No.: US 2023/0395072 A1
(43) Pub. Date: Dec. 7, 2023

(54) SYSTEM FOR COMPUTING NETWORK-INDEPENDENT APPLIANCE CONTROL USING NATURAL LANGUAGE PROCESSING AND USER FEEDBACK

(71) Applicant: ELECTROLUX HOME PRODUCTS, INC., Charlotte, NC (US)

(72) Inventor: John TAYLOR, Cornelius, NC (US)

(73) Assignee: ELECTROLUX HOME PRODUCTS, INC., Charlotte, NC (US)

(21) Appl. No.: 18/035,681

(22) PCT Filed: Dec. 9, 2020
(86) PCT No.: PCT/US2020/063904

§ 371 Date: May 5, 2023

(51) Int. Cl. G10L 15/22; G10L 15/02

(52) U.S. Cl. CPC G10L 15/22; G10L 15/02; G10L 2015/223

(57) ABSTRACT

An apparatus, method, and system are provided for computing network-independent appliance control using natural language processing and user feedback. In particular, the system may comprise an intelligent front end (e.g., a communications adapter) that may interface with a user and an electronic controller configured to transmit commands to the appliance. The communications adapter may comprise an artificial intelligence module with natural language understanding and/or natural language processing capabilities, where the module may receive auditory inputs from and provide auditory feedback to the user to allow voice-based control of the appliance. The front-end system may further be configured to store voice recognition data and/or natural language processing data locally, such that the voice control may continue to function even in the absence of a network connection to other computing systems. In this way, the system may provide an effective way to provide voice-based control functionality to an appliance.

### FIELD OF THE INVENTION

The present disclosure embraces an apparatus, method, and system for network-independent appliance control using natural language processing and user feedback.

### BACKGROUND

There is a need for a network-independent method for controlling an appliance.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

An apparatus, method, and system are provided for computing network-independent appliance control using natural language processing and user feedback. In particular, the system may comprise an intelligent front end (e.g., a communications adapter) that may interface with a user and an electronic controller configured to transmit commands to the appliance. The communications adapter may comprise an artificial intelligence module with natural language understanding and/or natural language processing capabilities, where the module may receive auditory inputs from and provide auditory feedback to the user to allow voice-based control of the appliance. In some or all of the embodiments disclosed herein, the front-end system may further be configured to store voice recognition data and/or natural language processing data locally, such that the voice control may continue to function even in the absence of a network connection to other computing systems. In this way, the system may provide an effective way to provide voice-based control functionality to an appliance.

The apparatus, method, and system as described herein may include additional embodiments and/or aspects of any of the embodiments, such as any single embodiment and/or aspect or any combination of embodiments and/or aspects described below and/or in connection with one or more other apparatus, methods, or systems described elsewhere herein.

A first embodiment provides a communications adapter apparatus for network-independent appliance control using natural language processing and user feedback. The apparatus may comprise a memory device with computer-readable program code stored thereon; a connector structured to operatively connect the apparatus to an appliance controller of an appliance; a communication device; and a processing device operatively coupled to the memory device and the communication device. The processing device may be configured to execute the computer-readable program code to receive a voice command to control the appliance from a user; parse the voice command using a natural language understanding (“NLU”) module; translate the voice command into a set of tokens, wherein the set of tokens corresponds to a set of interface elements on the appliance interface of the appliance; transmit the tokens to the appliance controller of the appliance; and based on the tokens, control the appliance through the appliance controller of the appliance.

In a first aspect of the first embodiment, the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

In a second aspect of the first embodiment, either alone or in combination with the first aspect of the first embodiment, translating the voice command further comprises accessing a token database, the token database comprising one or more entries associated with one or more appliances, wherein each of the one or more entries comprises one or more tokens associated with one or more functions of the appliance; identifying a set of entries within the one or more entries, wherein the set of entries are associated with the appliance; identifying a sequence of tokens associated with the appliance and corresponding to the voice command; and generating the sequence of tokens based on the one or more entries within the token database.

In a third aspect of the first embodiment, either alone or in combination with one or more of the first and second aspects of the first embodiment, the voice command comprises a custom user-defined command, wherein parsing the voice command comprises detecting the custom user-defined command from the voice command, and wherein the sequence of tokens is associated with the custom user-defined command.

In a fourth aspect of the first embodiment, either alone or in combination with one or more of the first through third aspects of the first embodiment, receiving the voice command further comprises detecting that the user has spoken a wake word associated with the appliance.

In a fifth aspect of the first embodiment, either alone or in combination with one or more of the first through fourth aspects of the first embodiment, the computer-readable program code further causes the processing device to output an auditory confirmation request to the user, wherein the auditory confirmation request prompts the user to confirm the voice command; and receive an auditory confirmation from the user, wherein the auditory confirmation confirms the voice command.

In a sixth aspect of the first embodiment, either alone or in combination with one or more of the first through fifth aspects of the first embodiment, the computer-readable program code further causes the processing device to initiate a supervised learning process, the supervised learning process comprising prompting the user for feedback regarding a result of controlling the appliance; receiving, from the user, auditory feedback regarding the result of controlling the appliance; and based on the auditory feedback, adjust, using an artificial intelligence (“AI”) module, one or more predefined settings associated with the appliance.

A second embodiment provides a computer-implemented method for network-independent appliance control using natural language processing and user feedback, the computer-implemented method comprising receiving, using a communications adapter apparatus communicatively coupled to an appliance controller of an appliance, a voice command to control the appliance from a user; parsing the voice command using a natural language understanding (“NLU”) module; translating, using the NLU module, the voice command into a set of tokens, wherein the set of tokens corresponds to a set of interface elements on the appliance interface of the appliance; transmitting the tokens to the appliance controller of the appliance; and based on the tokens, controlling the appliance through the appliance controller of the appliance.

In a first aspect of the second embodiment, the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

In a second aspect of the second embodiment, either alone or in combination with the first aspect of the second embodiment, translating the voice command further comprises accessing a token database, the token database comprising one or more entries associated with one or more appliances, wherein each of the one or more entries comprises one or more tokens associated with one or more functions of the appliance; identifying a set of entries within the one or more entries, wherein the set of entries are associated with the appliance; identifying a sequence of tokens associated with the appliance and corresponding to the voice command; and generating the sequence of tokens based on the one or more entries within the token database.

In a third aspect of the second embodiment, either alone or in combination with one or more of the first and second aspects of the second embodiment, the voice command comprises a custom user-defined command, wherein parsing the voice command comprises detecting the custom user-defined command from the voice command, and wherein the sequence of tokens is associated with the custom user-defined command.

In a fourth aspect of the second embodiment, either alone or in combination with one or more of the first through third aspects of the second embodiment, receiving the voice command further comprises detecting that the user has spoken a wake word associated with the appliance.

In a fifth aspect of the second embodiment, either alone or in combination with one or more of the first through fourth aspects of the second embodiment, the computer-implemented method further comprises outputting an auditory confirmation request to the user, wherein the auditory confirmation request prompts the user to confirm the voice command; and receiving an auditory confirmation from the user, wherein the auditory confirmation confirms the voice command.

A third embodiment provides an appliance with integrated network-independent appliance control functionality using natural language processing and user feedback. The appliance may comprise an appliance interface; an appliance controller operatively coupled to the appliance interface; and a communications adapter apparatus communicatively coupled to the appliance controller, wherein the apparatus comprises a processor; a communication interface; and a memory having executable code stored thereon. The, when executed by the processor, may cause the processor to receive a voice command to control the appliance from a user; parse the voice command using a natural language understanding (“NLU”) module; translate the voice command into a set of tokens, wherein the set of tokens corresponds to a set of interface elements on the appliance interface of the appliance; transmit the tokens to the appliance controller of the appliance; and based on the tokens, control the appliance through the appliance controller of the appliance.

In a first aspect of the third embodiment, the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

In a second aspect of the third embodiment, either alone or in combination with the first aspect of the third embodiment, translating the voice command further comprises accessing a token database, the token database comprising one or more entries associated with one or more appliances, wherein each of the one or more entries comprises one or more tokens associated with one or more functions of the appliance; identifying a set of entries within the one or more entries, wherein the set of entries are associated with the appliance; identifying a sequence of tokens associated with the appliance and corresponding to the voice command; and generating the sequence of tokens based on the one or more entries within the token database.

In a third aspect of the third embodiment, either alone or in combination with one or more of the first and second aspects of the third embodiment, the voice command comprises a custom user-defined command, wherein parsing the voice command comprises detecting the custom user-defined command from the voice command, and wherein the sequence of tokens is associated with the custom user-defined command.

In a fourth aspect of the third embodiment, either alone or in combination with one or more of the first through third aspects of the third embodiment, receiving the voice command further comprises detecting that the user has spoken a wake word associated with the appliance.

In a fifth aspect of the third embodiment, either alone or in combination with one or more of the first through fourth aspects of the third embodiment, the executable code further causes the processor to output an auditory confirmation request to the user, wherein the auditory confirmation request prompts the user to confirm the voice command; and receive an auditory confirmation from the user, wherein the auditory confirmation confirms the voice command.

In a sixth aspect of the third embodiment, either alone or in combination with one or more of the first through fifth aspects of the third embodiment, the executable code further causes the processor to initiate a supervised learning process, the supervised learning process comprising prompting the user for feedback regarding a result of controlling the appliance; receiving, from the user, auditory feedback regarding the result of controlling the appliance; and based on the auditory feedback, adjust, using an artificial intelligence (“AI”) module, one or more predefined settings associated with the appliance.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the appliance control system, in accordance with one embodiment of the present disclosure;

FIG. 2 illustrates a block diagram illustrating the communications adapter, the appliance interface, the appliance controller, and the user device in more detail, in accordance with some embodiments;

FIG. 3 illustrates an operating environment for an appliance with an integrated appliance control system, in accordance with one embodiment of the present disclosure; and

FIG. 4 illustrates a process flow for network-independent appliance control using natural language processing and user feedback, in accordance with some embodiments.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“The system” as used herein may refer to the computing systems, devices, software, applications, hardware, and/or other resources that may perform the functions as described herein. Accordingly, the system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer (“SBC”), system on a chip (“SoC”), smart device, or laptop. In other embodiments, the computing system may be a stationary unit such as a personal desktop computer, networked terminal, IoT device, or the like.

“User” as used herein may refer to an individual who may interact with the system to access the functions therein.

Accordingly, the term “user device” or “mobile device” may refer to mobile phones, personal computing devices, tablet computers, wearable devices, and/or any stationary or portable electronic device capable of receiving and/or storing data therein.

“Appliance” as used herein may refer to various devices or apparatuses which may be used in a home or office setting to perform specific functions. Examples of such appliances may include refrigerators, freezers, stoves, microwaves, washing machines, dryers, dishwashers, air conditioners, water heaters, or the like. Each appliance may comprise an appliance controller which may be configured to detect various conditions of the appliance 120 and/or control the various functions of the appliance. For instance, if the appliance is a refrigerator, the appliance controller may detect conditions and/or change settings such as the temperature of the refrigerator, current temperature setting, the status of internal lights, coolant levels, or the like. If the appliance is an oven, the appliance controller may detect conditions and/or change settings such as current oven temperature, temperature setting, timer setting, current time, or the like.

“Natural language processing” or “NLP” as used herein may refer to artificial intelligence technology that may allow computing devices to process and analyze language data. “Natural language understanding” or “NLU” as used herein may refer to the process by which a computing device (e.g., a device with NLP functionality) understands or comprehends natural language. Accordingly, the system may use NLP/NLU to receive language inputs from a user (e.g., voice commands comprising natural language) to process, analyze, and interpret the language inputs to drive the processes described herein. In some or all of the embodiments disclosed herein, the system may further be configured to provide language outputs to the user (e.g., through voice feedback created through natural language generation or “NLG” or pre-recorded audio samples). While voice inputs and outputs are described for exemplary purposes, it is within the scope of the disclosure for the language inputs and/or outputs to be in other forms. For instance, the user may provide language inputs in written form (e.g., via a smartphone) and the system may provide language outputs in written form (e.g., via a display on the appliance and/or the front-end module).

Embodiments of the present disclosure provide a system for network-independent appliance control using natural language processing and user feedback. Specifically, the system may provide voice control functionality to allow a user to control an appliance (e.g., an oven, dishwasher, washing machine, or the like) through verbal commands. In some or all of the embodiments disclosed herein, the system may also be configured to provide auditory feedback to the user to confirm the commands received from the user and/or to update the user with information about the appliance (e.g., a status of the appliance). In some or all of the embodiments disclosed herein, the system may further be configured to operate independently of a network connection to other computing systems (e.g., an internet connection) such that the voice control functionality may continue to be used by the user despite adverse network conditions (e.g., network latency or cloud server downtime) or deliberate isolation of the appliance from the network.

The system may comprise a communications adapter in operative communication with an electronic appliance controller via a connector, cable, or wire configured to send and/or receive electrical signals, data, and/or power. For instance, the communications adapter may be connected to a serial port of the appliance controller via a cable or wire harness such that the communication adapter may transmit commands to the appliance controller and/or receive appliance-related data (or “appliance data”) from the appliance controller. The appliance data processed by the communications adapter may be dependent on the appliance being controlled. For example, appliance data received from an oven may include the temperature setting of the oven, the measured internal temperature of the oven, the status of the oven (e.g., on or off), the status of the interior oven light, or the like.

The communications adapter may comprise an NLU module (e.g., an SoC with built-in NLP/NLU functionality) that is configured to receive voice inputs from the user and transmit control commands to the appliance via the appliance controller. The logic for the NLU module may be stored locally (e.g., on a non-volatile memory device) such that the NLU/NLP functions may be available even in the absence of an internet connection. In this regard, the NLU model may be configured to detect the voice of the user (which may contain speech), parse the speech of the user to recognize words and phrases, detect the presence of one or more commands directed to the appliance within the speech of the user (which may be referred to herein as “user voice commands”), and translate the user voice commands to one or more commands that may be recognized by the appliance controller (which may be referred to herein as “appliance commands”).

In one embodiment, the NLU module may comprise an on-board neural processing unit (“NPU”) that may call on locally stored machine learning data (e.g., NLU/NLP training data) to detect the voice of the user (e.g., a wake word followed by one or more spoken voice commands), compare the auditory input from the user with the locally stored machine learning data to determine what words or phrases were most likely spoken by the user, and translate the words or phrases spoken by the user into one or more commands to control the appliance. By having on-board intelligence and locally stored machine learning data in this manner, the system may be able to understand the commands of the user without the need to access machine learning data hosted on external networks (e.g., a cloud).

The communications adapter may then transmit the appliance commands to the appliance controller, which in turn may create one or more changes to the configuration of the appliance according to the appliance commands. In some or all of the embodiments disclosed herein, the appliance commands may be serial commands that may mimic the types of commands that may be received from a touch interface of the appliance (e.g., keypad or key presses, touchscreen inputs, or the like). Accordingly, in some or all of the embodiments disclosed herein, the communications adapter may be retrofitted to an existing appliance to provide voice recognition functionality with minimal modification to the hardware, firmware, and/or software of the appliance. In other embodiments, the communications adapter may be incorporated into an appliance during the manufacturing process of the appliance.

In an exemplary embodiment, a user may wish to use a voice command to control an oven. To begin the process, the user may activate the system by speaking a wake word. The system, upon detecting the wake word, may be configured to execute its NLU/NLP processes on the speech provided by the user that follows the wake word. The user may then issue one or more commands to the oven by the user's speech. For instance, the user may say “set the oven to bake at 375 degrees.” The NLU module may parse the user's speech to identify key words associated with the appliance. Continuing the example, the NLU module may recognize the word “bake” and “375 degrees” as relevant parameters associated with the commands to be sent to the appliance. In some or all of the embodiments disclosed herein, the NLU module may be configured to confirm the command received by auditory feedback to the user. For instance, the NLU module may produce a voice output (e.g., through an integrated speaker on the communications adapter) that may pose a confirmatory question to the user, such as “setting the oven to bake at 375 degrees, do you concur?” In such embodiments, the NLU module may proceed only after receiving a confirmatory input from the user (e.g., the user says “yes” in response to the voice output produced by the NLU module).

Based on the user commands detected from the user's speech, the NLU module may translate the parameters into one or more appliance commands to be provided to the appliance controller. In particular, the NLU module may read a token database associated with a particular appliance, where the token database comprises entries containing mappings of key inputs to individual unique tokens. For example, the key interface for an oven may contain keys corresponding to “bake,” “time,” “ok,” “start,” and “cancel,” along with individual keys for numbers 0-9. Each key may be associated with a particular token, where the token indicates the type of signal to be sent to the appliance controller. For instance, the “bake” key may be associated with token “A1,” the number keys may be associated with tokens “N0” to “N9,” and the “ok” key may be associated with token “O1.” Based on the token database, the system may determine the correct sequence of tokens to transmit to the appliance controller (e.g., the one or more appliance commands) corresponding to the user commands parsed by the NLU module. Continuing the example, the correct sequence for “set the oven to bake at 375 degrees” may be key inputs corresponding to “bake,” “3,” “7,” “5,” and “ok.” According, the communications adapter may send, in sequence, the tokens A1, N3, N7, N5, and O1 to the appliance controller. By mimicking key presses to control the appliance, the system may require little to no modification of the appliance to provide the control functionality.

It will be appreciated by those skilled in the art that the functions of the system may be applicable to other types of appliances and that the scope of the disclosure is not intended to be limited to oven appliances. In another exemplary embodiment, the user may issue a voice command to control a dishwasher, such as “run a heavy wash cycle with heated dry.” In such an embodiment, the NLU module may parse the key phrases “wash cycle” and “heated dry” and perform a lookup of the token database associated with the dishwasher to determine the correct sequence of key inputs (and tokens) corresponding to a wash cycle with the heated dry function. Once the sequence has been determined, the communications adapter may transmit the sequence of tokens to the appliance controller.

In some or all of the embodiments disclosed herein, the communications adapter may further comprise an appliance database that may in turn store appliance-specific data (e.g., data associated with a particular appliance). In particular, if the appliance is an oven, the appliance-specific data stored within the database of the communications adapter may include presets for various parameters of the appliance. In an exemplary embodiment, the appliance-specific data may include recipe-specific parameters for an oven. The user may provide a voice command such as “set oven to bake a turkey.” Upon parsing the user's command using the NLU module, the system may read the appliance-specific data within the database to set the relevant parameters (e.g., oven temperature, bake time, and the like) based on the user-specified command (e.g., a command to bake a turkey according to the preset recipe).

In some or all of the embodiments disclosed herein, the communications adapter may also pose one or more voice outputs to the user to gain additional information relevant to the fulfillment of the voice command. For instance, the system may prompt the user to state a weight of the item being cooked or to state whether the item is frozen, chilled, or thawed. Based on receiving the user's response to the one or more voice outputs, the system may adjust its appliance parameters accordingly (e.g., to determine cook time and temperature). In such embodiments, the appliance-specific data may further comprise preset data for various types of food at different food weights and/or temperatures. The appliance database may further comprise user-created custom appliance-specific data. For instance, the user may create appliance presets according to the user's preference or needs (e.g., a customized recipe). In some or all of the embodiments disclosed herein, the user may provide the customized presets by voice commands (e.g., “save current settings as ‘my custom recipe’”). In other embodiments, the user may provide the customized presents through an interface on the communications adapter (e.g., a touchscreen in operative communication with the communications adapter) or through a user device communicatively coupled with the communications adapter (e.g., the user provides the presets through an application on the user's mobile device which connects with the communications adapter).

In some or all of the embodiments disclosed herein, the communications adapter may further comprise an artificial intelligence (“AI”) module that may be configured to progressively adjust appliance-specific data (e.g., presets) over time based on machine learning. In this regard, the AI module may be trained using supervised learning based on feedback provided by the user. In an exemplary embodiment, the oven may finish a cooking cycle of the user's turkey as described above. Upon completion of the cooking cycle, the communications adapter may (e.g., via a voice output) prompt the user to provide feedback about the outcome of the cooking cycle (e.g., the turkey was too cold, overcooked, just right, or the like). Upon receiving the feedback from the user (e.g., by voice responses), the AI module may dynamically adjust the appliance parameters accordingly. For example, if the user provides feedback that the turkey was overcooked, the AI module may adjust the presets for the “turkey” setting in response to the user's feedback (e.g., by lowering the cook temperature and/or reducing cook time). In some or all of the embodiments disclosed herein, the AI module may further be configured to recognize the user's voice and distinguish the user's voice from other voices over time.

In other embodiments, the AI module may detect certain conditions based on data received from an appliance controller. For example, an oven may comprise an internal thermometer that may provide temperature data to the appliance controller. The AI module may read the temperature data (which reflects the actual temperature of the oven at various stages of cooking) and take the temperature data into account when selecting a temperature setting. The learning data may be stored as historical data that may be stored for access by the communications adapter (e.g., within a storage device located on the communications adapter or an external device accessible by the communications adapter) in subsequent learning operations. In this way, the AI module may adapt to the user's preferences and progressively optimize its stored presets over time.

The system as described herein confers a number of technological advantages over conventional appliance communication devices. For instance, by operating on a network-independent basis, the system is able to retain a flexible natural language-based voice activation functionality even in the presence of suboptimal network conditions (e.g., cloud server unresponsiveness or downtime, high network latency, or the like) or even the absence of an internet connection (e.g., networking hardware failure, service outage, firewall rules and settings, deliberate disconnection, or the like). Furthermore, by using an AI module, the system is able to optimize its appliance settings over time based on user feedback and/or collection of historical appliance data.

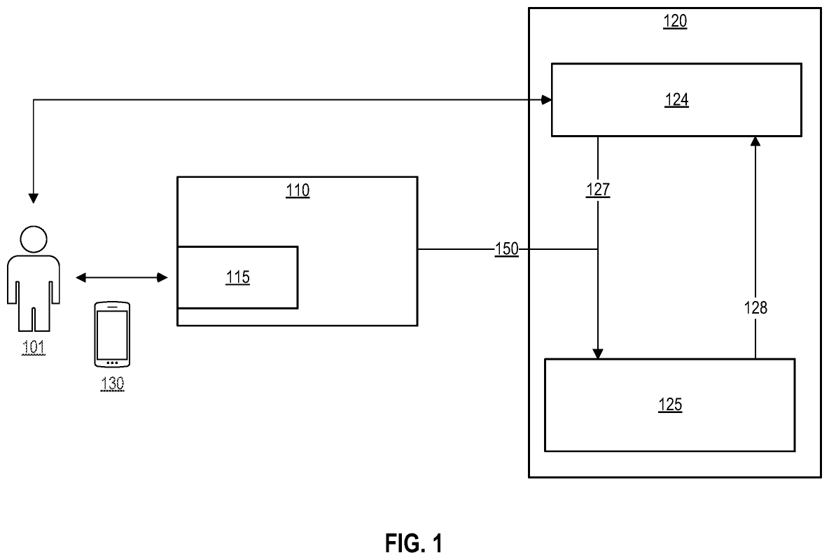

Turning now to the figures, FIG. 1 shows an operating environment for the appliance control system, in accordance with some embodiments. The system may comprise a communications adapter 110 in operative communication with an appliance 120 through a connector 150 (e.g., an electrical connector, cable, or wire) that is linked to an appliance controller 125 of the appliance 120. The connector 150 may be a wired connection such as a wiring or cable harness, data cable, or the like. In some or all of the embodiments disclosed herein, the communications adapter 110 may be powered through an independent power source (e.g., a power supply such as a power adapter, battery, or the like). In other embodiments, the communications adapter 110 may be powered through the electrical connector linked to the appliance controller 125. The communications adapter 110 may be configured to receive inputs from and/or provide outputs to a user 101, as will be described in further detail elsewhere herein.

The appliance 120 may be any type of device that may be used to accomplish certain tasks. Accordingly, examples of an appliance 120 may include, for instance, ovens, refrigerators, microwaves, ranges, washing machines, dryers, dishwashers, refrigerators, freezers, blenders, cookers, or the like. The appliance 120 may comprise an appliance interface 124 that may comprise various hardware, software, and/or firmware components to receive inputs from the user 101 and/or provide outputs to the user 101. For instance, the appliance interface 124 may comprise one or more interactable interface elements (e.g., buttons, keys, touch-activated regions, dials, knobs, sliders, or the like) that may be selected by the user 101 to activate one or more functions of the appliance 120 and/or set the parameters for operation of the appliance 120. The appliance interface 124 may further comprise one or more output elements, such as LCD/LED displays, dot matrix displays, audio speakers, or the like, where the output elements may indicate a current state of the appliance 120 (e.g., a number of seconds left on a timer displayed on a numerical LCD display).

The appliance interface 124 may transmit inputs received from the user 101 (e.g., key presses) to the appliance controller 125 as interface inputs 127. The appliance controller 125 may then change a configuration or state of the appliance 120 based on the interface inputs 127. In some or all of the embodiments disclosed herein, the appliance controller 125 may further be configured to read the current configuration or state of the appliance 120 and transmit one or more interface outputs 128 to the appliance interface 124. Examples of interface outputs 128 may include changes to a displayed value within the appliance interface 124 (e.g., current temperature, set temperature, current timer, or the like) or auditory outputs (e.g., alarms, beeps, buzzers, messages, or the like).

In an exemplary embodiment, the appliance 120 may be a microwave oven. In such embodiments, the appliance interface 124 may comprise one or more keys corresponding to the various functions of the microwave. For example, the appliance interface 124 may comprise numerical keys, an “enter” and/or “ok” key, “cancel key,” or the like. Accordingly, the appliance controller 125 may be configured to receive one or more signals corresponding with said keys from the appliance interface 124 as interface inputs 127. Based on the interface inputs 127, the appliance interface 124 may adjust heat settings, timer settings, clock settings, preset heating profiles, or the like based on the interface inputs 127. In some or all of the embodiments disclosed herein, the appliance controller 125 may further be configured to transmit one or more interface outputs 128 to the microwave's appliance interface 124, where the interface outputs 128 may be, for instance, a remaining cook time to be presented on a numerical display of the appliance interface 124, an auditory signal to be played on a speaker of the appliance interface 124 (e.g., a beep indicating that cooking has been completed), or the like.

The communications adapter 110 may comprise an NLU module 115, which in some or all of the embodiments disclosed herein may be an SoC with NLU and/or NLP functionality to parse natural language, understand natural language, and perform one or more processes based on the natural language. In this regard, the NLU module 115 may be configured to receive auditory inputs from the user 101 (e.g., a spoken sentence, phrase, or words containing one or more voice commands), parse the language from the auditory inputs, and translate the language into signals that may be recognized and understood by the appliance controller 125. The core functionality of the NLU module 115 (e.g., NLP libraries, machine learning data, or the like) may be stored locally to the NLU module 115 and/or the communications adapter 110 such that the functions of the NLU module 115 may be accessed even in the absence of network connections to exterior systems (e.g., an Internet connection).

Accordingly, the NLU module 115 may be configured to translate the voice commands of the user 101 into one or more key commands that emulate the interface inputs 127 received from the appliance interface 124. For example, if the user 101 gives a verbal command such as “run dishwasher with heavy wash and heated dry,” the NLU module 115 may parse and translate the verbal command into signals (e.g., a series of key presses) that emulate the interface inputs 127 that would have been received from the appliance interface 124. The communications adapter 110 may then transmit the translated signals to the appliance controller 125 via the connector 150. In this way, the system may provide voice command functionality with minimal changes to the appliance controller 125.

In some or all of the embodiments disclosed herein, the NLU module 115 may further be configured to provide auditory outputs to the user 101. In this regard, the NLU module 115 may comprise a speaker or other audio output device through which the auditory outputs may be presented to the user 101. For instance, the NLU module 115 may be configured to confirm the commands of the user 101 through voice outputs (e.g., “dishwasher on heavy wash and heated dry, is this correct?”). In other embodiments, the NLU module 115 may be configured to output information related to a configuration or status of the appliance 120 received by the communications adapter 110 from the appliance controller 125 through the connector 150. For example, if the appliance 120 is a refrigerator, the user 101 may ask “what is the current temperature of the refrigerator?” In response, the communications adapter 110 may read the current temperature information from the appliance controller 125. The NLU module 115 may then generate an auditory output (e.g., via natural language generation) that indicates the current temperature of the refrigerator (e.g., “the current temperature is 34 degrees Fahrenheit”).

In some or all of the embodiments disclosed herein, the communications adapter 110 may further be communicatively coupled with a user device 130, where the user device 130 may be a computing device operated by the user 101. Accordingly, the user device 130 may be a smartphone or other portable computing device of the user 101, though it is within the scope of the disclosure for the user device 130 to be any other type of computing system (e.g., a desktop computer, laptop computer, IoT device, wearable smart device, tablet, single board computer, or the like). In particular, the communications adapter 110 may communicate with the user device 130 through a wireless communication protocol (e.g., Wi-Fi, Bluetooth, or the like). In some or all of the embodiments disclosed herein, the user 101 may provide voice commands to the NLU module 115 through the user device 130, such as when the user 101 is located at a distance at which the user's voice commands may not be correctly detected or registered by the NLU module 115 (e.g., the user 101 is too far away from the NLU module 115 or the path between the user 101 and the NLU module 115 is obstructed). Similarly, the NLU module 115 may, in some or all of the embodiments disclosed herein, be configured to present its voice outputs through the user device 130. In some or all of the embodiments disclosed herein, the user 101 may use the user device 130 to access additional functionality of the communications adapter 110. For instance, the user 101 may, through a user interface presented on the user device 130, upload or select custom appliance settings or profiles, view appliance status information, create appliance-related presents (e.g., customized recipes), or the like.

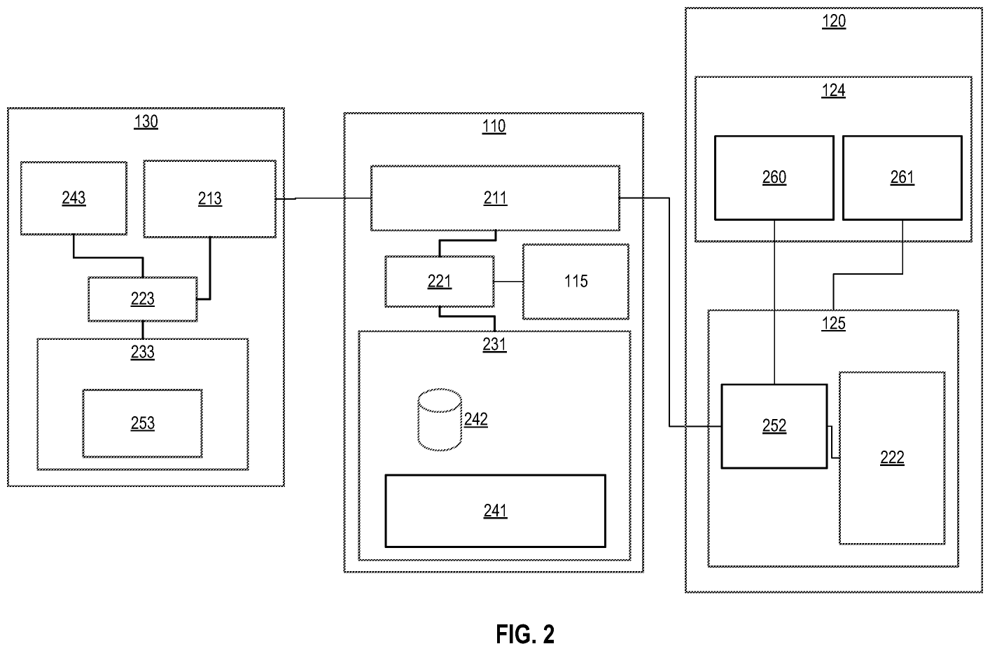

FIG. 2 is a block diagram illustrating the communications adapter 110, the appliance interface 124, the appliance controller 125, and the user device 130 in more detail, in accordance with some embodiments. The communications adapter 110 may be in operative communication with one or more other devices as shown in FIG. 2 over a network. “Network” as used herein may refer to a global area network (GAN), such as the Internet, a wide area network (WAN), a local area network (LAN), or any other type of network or combination of networks. The network may provide for wireline, wireless, or a combination wireline and wireless communication between devices on the network.

The communications adapter 110 may comprise a processor 221 communicably coupled to such devices as a communication interface 211 and a memory 231. The processor 221, and other processors described herein, typically includes circuitry for implementing communication and/or logic functions. For example, the processor 221 may include a digital signal processor device, a microprocessor device, and various analog to digital converters, digital to analog converters, and/or other support circuits. The communications adapter 110 may use the communication interface 211 to communicate with other devices over the network. “Communication interface” as used herein may include an Ethernet interface, an antenna coupled to a transceiver configured to operate on a cellular data, GPS, or WiFi signal, and/or a near field communication (“NFC”) interface. In some embodiments, a processing device, memory, and communication device may be components of a controller, where the controller executes one or more functions based on the code stored within the memory.

As used herein, “memory” includes any computer readable medium (as defined herein below) configured to store data, code, or other information. The memory may include volatile memory, such as volatile Random-Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like. The memory 231 may have an adapter application 241 stored thereon, where the adapter application 241 contains the code and/or logic to retrieve data from the appliance controller 125, send outputs and receive inputs to and from the user device 130, access and implement appliance configuration profiles, and/or send commands to the appliance controller 125, among other functions.

The processor 221 of the communications adapter 110 may further be operatively coupled to an NLU module 115, which in some or all of the embodiments disclosed herein may be an SoC with natural language processing capabilities. Accordingly, the NLU module 115 may comprise and/or be operatively coupled to hardware and/or software components to receive auditory inputs from the user 101 (e.g., a microphone or other audio capture device) and/or provide auditory outputs to the user 101 (e.g., a speaker or other audio output device). In some or all of the embodiments disclosed herein, the NLU module 115 may further be communicatively coupled with the user device 130 via the communication interface 211 of the communications adapter 110.

In some or all of the embodiments disclosed herein, the memory 231 of the communications adapter 110 may further have an appliance database 242 stored thereon. The appliance database 242 may contain information related to appliances, such as the identities of appliances, appliance configurations and settings, appliance presets, custom user-defined settings and/or presets, and the like. In some or all of the embodiments disclosed herein, the appliance database 242 may further comprise machine learning data to be used by the NLU module 115 to progressively adapt its functionality to the user 101 and/or the associated appliances over time, as described in further detail elsewhere herein.

Typically, the communications adapter 110 is in operative communication with the appliance controller 125 through a connection port 252 which is communicatively coupled with a control board 222 within the appliance controller 125. In some or all of the embodiments disclosed herein, the appliance 120 may further comprise a data transfer cable which connects the connection port 252 to the control board 222 of the appliance controller 125. The connection port 252 may be, for example, an electrical socket, data port, slot, or other type of connection point which facilitates the input and output of electrical signals and/or data. For instance, the connection port 252 may be a USB port, USB micro or mini port, USB type-C port, Thunderbolt port, serial port, or the like. The control board 222 may comprise various controllers, resistors, capacitors, transformers, switches, fuses, wires, or the like, which allow the appliance controller 125 to receive information about the appliance 120 (e.g., the internal temperature reading from a thermometer) and/or create changes in configuration in the appliance 120 (e.g., an actuation of a solenoid to allow water to flow into a washing machine). Accordingly, the communications adapter 110 may be configured to send appliance commands to the appliance controller 125 via the connection port 252 and/or receive information from the appliance controller 125.

The appliance 120 may comprise an appliance interface 124 and the appliance controller 125 as described above. The appliance 120 may further comprise a power supply cable which connects the appliance 120 to a power source (e.g., electrical outlet) to provide power to the appliance 120, appliance interface 124, and/or the appliance controller 125. In other embodiments, the appliance 120 may comprise a portable power supply (e.g., a battery). The data transfer cable may be integrated with the power supply cable of the appliance such that the data transfer cable runs adjacent to and alongside the power supply cable. In such embodiments, the connection port 252 may be a terminal point of the data transfer cable which is located near the end of the power supply cable that connects to the power source. For example, the connection port 252 may be a USB port that is integrated into a transformer of the power supply cable. In such embodiments, the communications adapter 110 may, through the connector 150 (e.g., a USB cable), be operatively linked to the connection port 252 (e.g., a USB port), which may be external to the appliance 120, to allow the communications adapter 110 to communicate with the control board 222 of the appliance controller 125.

The appliance interface 124 of the appliance 120 may comprise an input component 260 which may comprise one or more interface elements to receive inputs (e.g., from a user) to control the appliance 120. Accordingly, the input component 260 may comprise keys, buttons, dials, capacitive touch surfaces, touchscreens, or the like, which may be activated to send certain signals from the appliance interface 124 to the appliance controller 125 (e.g., via the connection port 252). The appliance interface 124 may further comprise an output component 261 which may be configured to provide information about the state or configuration of the appliance 120. For example, the output component 261 may comprise display components (e.g., a numerical display, color display, touchscreen, indicator lights, or the like) and/or audio components (e.g., speakers, buzzers, chimes, or the like) which may be activated based on the signals received from the appliance controller 125.

The user device 130 may comprise a processor 223 communicatively coupled with a communication interface 213 and a memory 233 having a user application 253 stored thereon. The user application 253 may allow the user to view information about the appliance (e.g., the current state of the appliance) and/or issue commands to the communications adapter 110 and/or the appliance controller 125. The user application 253 may also, in some or all of the embodiments disclosed herein, transmit voice commands to and/or receive voice outputs from the NLU module 115 of the communications adapter 110.

The user device 130 may further comprise a user interface 243 that may receive inputs from and provide outputs to the user. In this regard, the user interface 243 may comprise the hardware and software implements to accept input from and provide output to the user. Accordingly, the user interface 243 may comprise hardware such as a display, audio output devices, projectors, and the like, or input devices such as keyboards, mice, sensors, cameras, microphones, biometric input devices (e.g., fingerprint readers), and the like. The user interface 243 may further comprise software such as a graphical or command-line interface through which the user may provide inputs and/or receive outputs from the user device 130, which then allows the user to communicate with the communications adapter 110 and/or the appliance controller 125. It should be understood that the display on which the user interface 243 is presented may include an integrated display (e.g. a tablet or smartphone screen) within the user device 130, or an external display device (e.g. a computer monitor or television).

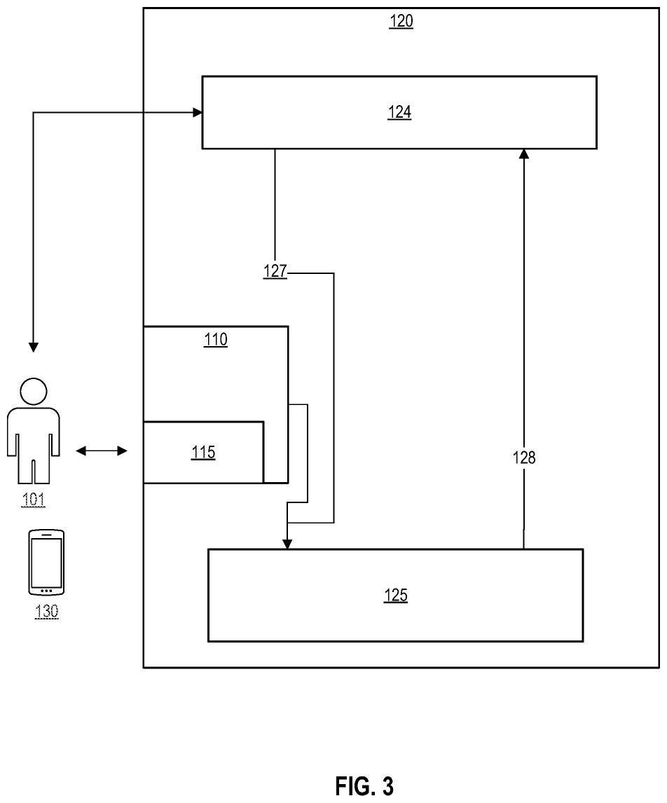

FIG. 3 illustrates an operating environment for an appliance with an integrated appliance control system, in accordance with one embodiment of the present disclosure. In particular, FIG. 3 depicts an appliance 120 comprising an appliance interface 124, a communications adapter 110, and an appliance controller 125 in operative communications with one another. In such an embodiment, the communications adapter 110 may be an integrated part of the appliance 120 such that the appliance 120 natively supports the NLU/NLP functionality of the communications adapter 110 as described herein.

In this regard, the communications adapter 110 may comprise an NLU module 115, which in some embodiments may be an SoC with on-board NLU capabilities (e.g., using an NPU) and locally stored machine learning data related to NLU/NLP. The NLU module 115 may further comprise input and/or output devices for interfacing with a user 101 and/or a user device 130 (e.g., audio input and/or output devices, wireless communications devices, and the like).

The appliance interface 124 may be configured to provide interface inputs 127 to the appliance controller 125 and/or receive interface outputs 128 from the appliance controller 125, as described elsewhere herein. Furthermore, the communications adapter 110 may be configured to transmit the appliance commands generated by the NLU module 115 and transmit such commands to the appliance controller 125 to control the appliance. In some embodiments, the communications adapter 110 may further be configured to retrieve appliance data from the appliance controller 125 and present such appliance data to the user 101 and/or the user device 130, as also described elsewhere herein.

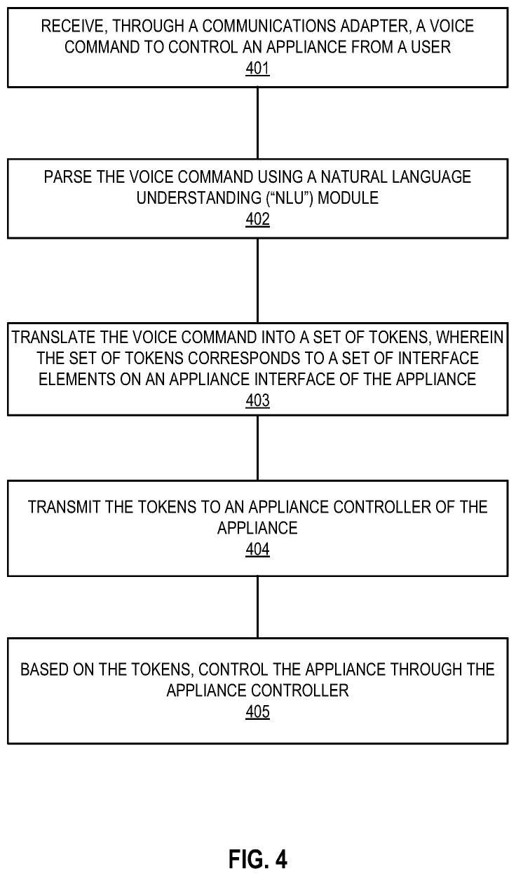

FIG. 4 illustrates a process flow for network-independent appliance control using natural language processing and user feedback, in accordance with some embodiments of the present disclosure. The process begins at block 401, where a system receives, through a communications adapter, a voice command to control an appliance from a user. The voice command may be spoken by the user and detected by an audio capture device within the system. For instance, a communications adapter may comprise an NLU module with an integrated microphone which may detect the voice of the user. In other embodiments, the system may detect the user's voice through a microphone within the appliance. In yet other embodiments, the user's voice may be captured through a user device owned and/or operated by the user, such as a smartphone or other portable device.

In some or all of the embodiments disclosed herein, the system may be activated by the user's use of a “wake word” followed by an identification of the appliance to be controlled. For instance, the user who wishes to control an oven may say the words “wake oven,” which will cause the communications adapter to recognize any following voice inputs from the user as commands to be sent to control the oven. An exemplary embodiment is provided for illustrative purposes. The user may say “wake oven,” followed by the phrase “bake at 300 degrees for 25 minutes.” Upon detecting the wake word (e.g., “wake oven”), the system may recognize the phrase “bake at 300 degrees for 25 minutes” as the voice command from the user indicating how the appliance is to be controlled. In this way, the system may be able to identify the particular appliance to which the voice command applies, thereby allowing the system to distinguish the target appliance from other voice-enabled appliances.

The process continues to block 402, where the system parses the voice command using a natural language understanding (“NLU”) module. In particular, the NLU module may be configured to recognize the spoken words within the user's voice command that correspond to parameters, settings, profiles, configurations, or functions of the appliance. Continuing the above example, the NLU module may recognize, based on the wake word, that the user is attempting to control the oven. Accordingly, the NLU module may parse the following voice inputs from the user to identify commands corresponding to the functionality of the oven, such as the cooking mode (e.g., bake), the temperature (e.g., 300 degrees), cook time (e.g., 25 minutes), and the like.

In other embodiments, the communications adapter may store custom appliance settings, presets, or configuration as designated by the user. For example, if the appliance is an oven, the user may store custom recipes (e.g., “my baguette recipe”) that have certain appliance settings associated with the recipe (e.g., 500 degrees Fahrenheit for 15 minutes). Accordingly, if the user's voice command is “set oven for my baguette recipe,” the NLU module may recognize the custom settings within the voice command and change the configuration of the appliance according to the custom settings.

In some or all of the embodiments disclosed herein, the NLU module may be configured to confirm with the user the commands parsed and/or detected by the NLU module. In this regard, the NLU module may present an auditory prompt to the user (e.g., “bake at 300 degrees for 25 minutes, is this correct?”) to verify that the voice commands have been correctly detected by the NLU module. If the user confirms the prompt (e.g., by saying “yes”), the system may proceed with the process described herein. However, if the user rejects the prompt (e.g., by saying “no,”), the NLU module may be configured to prompt the user to once again provide a voice input. The confirmation process may continue until the user has given a verbal confirmation of the commands detected by the NLU module.

The process continues to block 403, where the system translates the voice command into a set of tokens, wherein the set of tokens corresponds to a set of interface elements on an appliance interface of the appliance. In particular, each token may correspond to a signal sent from the appliance interface to the appliance controller based on the user interacting with an interface element on the appliance interface. For example, each token may be associated with a particular key on the appliance interface (e.g., numerical keys, “bake” key, “start” key, “time” key, “OK” key, and the like). Continuing the above example, the numerical keys (e.g., digits 0-9) on the appliance interface may be associated with tokens N1-N9, the “bake” key may be associated with token A1, the “time” key may be associated with token T1, the “OK” key may be associated with token O1, and the “start” key may be associated with token S1.

The set of tokens may be generated in the order that would be required by the particular appliance and/or particular interface. For instance, the protocol for setting the oven to bake at 300 degrees for 25 minutes may include the following sequence of key presses on the appliance interface: BAKE, 3, 0, 0, TIME, 2, 5, OK, START. In such a scenario, the set of tokens may include the following sequence of tokens to represent the command specified by the user: A1, N3, N0, N0, T1, N2, N5, O1, S1.

It should be understood that the set/series of tokens generated by the system may be dependent on the appliance to be controlled, as even appliances of the same type may have a different protocol (e.g., a different sequence of key presses) needed to change a configuration of the appliance in a particular manner. Accordingly, in some or all of the embodiments disclosed herein, the system may comprise a token database which may be stored on the communications adapter. The token database may comprise entries for the various appliances (e.g., appliance name, make, model number, or the like), various tokens that may be associated with particular appliances, and the protocols for accessing certain functions of the appliance (e.g., the sequence of tokens needed to set a washing machine to run a wash on the “permanent press” setting). Therefore, in some or all of the embodiments disclosed herein, translating the voice command into a set of tokens may further comprise accessing a token database, identifying one or more tokens associated with the appliance, identifying a protocol associated with the one or more tokens, and arranging a sequence of the one or more tokens based on the information within the token database.

The process continues to block 404, where the system transmits the tokens to an appliance controller of the appliance. The communications adapter may be connected to the appliance controller via a wire or cable connected to a serial port of the appliance. The serial port of the appliance may be configured to receive signals from the appliance interface and/or the communications adapter. In some or all of the embodiments disclosed herein, the appliance controller may be configured to distinguish between the source of the signals (e.g., by identifying the hardware ID's of the appliance interface and/or the communications adapter) for diagnostic purposes. For instance, if a communications error is detected between the communications adapter and the appliance controller, the appliance controller may be configured to display an error message on the appliance interface indicating the communications error. In other embodiments, the tokens may be transmitted to the appliance controller may completely emulate the key presses of the appliance interface, such that the appliance controller is not able to distinguish whether the signals are coming from the appliance interface or the communications adapter. In this way, the system may be able to provide a way to retrofit legacy appliances with minimal to no modification to existing appliance controllers.

The process continues to block 405, where the system, based on the tokens, controls the appliance through the appliance controller. In some or all of the embodiments disclosed herein, controlling the appliance may include changing a configuration of the appliance. Continuing the above example, the system may, based on the sequence of tokens generated, cause the oven to change its configuration to bake at 300 degrees for 25 minutes. In this way, the configuration of the appliance may be changed in the same manner as it would have been changed had the appliance interface been used.

In other embodiments, controlling the appliance may comprise reading appliance status information from the appliance controller and presenting the status information to the user (e.g., via a voice output). For instance, the user may ask “what is the current temperature of the oven?” In such scenarios, controlling the appliance may comprise reading the temperature information from the appliance controller (which in turn may read temperature information from an internal thermostat or thermometer) and producing a voice output to the user comprising the temperature information (e.g., “the current temperature of the oven is 300 degrees Fahrenheit”).

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A communications adapter apparatus for network-independent appliance control using natural language processing and user feedback, the apparatus comprising:
a memory device with computer-readable program code stored thereon;
a connector structured to operatively connect the apparatus to an appliance controller of an appliance;
a communication device; and
a processing device operatively coupled to the memory device and the communication device, wherein the processing device is configured to execute the computer-readable program code to:
receive a voice command to control the appliance from a user;
parse the voice command using a natural language understanding (“NLU”) module;
translate the voice command into a set of tokens, wherein the set of tokens corresponds to a set of interface elements on an appliance interface of the appliance;
transmit the tokens to the appliance controller of the appliance; and
based on the tokens, control the appliance through the appliance controller of the appliance.

2. The communications adapter apparatus of claim 1, wherein the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

3. The communications adapter apparatus of claim 1, wherein translating the voice command further comprises:
accessing a token database, the token database comprising one or more entries associated with one or more appliances, wherein the one or more entries comprise one or more tokens associated with one or more appliance functions;
identifying a set of entries within the one or more entries, wherein the set of entries are associated with the appliance;
identifying a sequence of tokens associated with the appliance and corresponding to the voice command; and
generating the sequence of tokens based on the one or more entries within the token database.

4. The communications adapter apparatus of claim 3, wherein the voice command comprises a custom user-defined command, wherein parsing the voice command comprises detecting the custom user-defined command from the voice command, and wherein the sequence of tokens is associated with the custom user-defined command.

5. The communications adapter apparatus of claim 1, wherein receiving the voice command further comprises detecting that the user has spoken a wake word associated with the appliance.

6. The communications adapter apparatus of claim 1, wherein the computer-readable program code further causes the processing device to:
output an auditory confirmation request to the user, wherein the auditory confirmation request prompts the user to confirm the voice command; and
receive an auditory confirmation from the user, wherein the auditory confirmation confirms the voice command.

7. The communications adapter apparatus of claim 1, wherein the computer-readable program code further causes the processing device to initiate a supervised learning process, the supervised learning process comprising:
prompting the user for feedback regarding a result of controlling the appliance;
receiving, from the user, auditory feedback regarding the result of controlling the appliance; and
based on the auditory feedback, adjust one or more predefined settings associated with the appliance using an artificial intelligence (“AI”) module.

8. A computer-implemented method for network-independent appliance control using natural language processing and user feedback, the computer-implemented method comprising:
receiving, using a communications adapter apparatus communicatively coupled to an appliance controller of an appliance, a voice command to control the appliance from a user;
parsing the voice command using a natural language understanding (“NLU”) module;
translating, using the NLU module, the voice command into a set of tokens, wherein the set of tokens corresponds to a set of interface elements on an appliance interface of the appliance;
transmitting the tokens to the appliance controller of the appliance; and
based on the tokens, controlling the appliance through the appliance controller of the appliance.

9. The computer-implemented method of claim 8, wherein the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

10. The computer-implemented method of claim 8, wherein translating the voice command further comprises:
accessing a token database, the token database comprising one or more entries associated with one or more appliances, wherein the one or more entries comprise one or more tokens associated with one or more appliance functions;
identifying a set of entries within the one or more entries, wherein the set of entries are associated with the appliance;
identifying a sequence of tokens associated with the appliance and corresponding to the voice command; and
generating the sequence of tokens based on the one or more entries within the token database.

11. The computer-implemented method of claim 10, wherein the voice command comprises a custom user-defined command, wherein parsing the voice command comprises detecting the custom user-defined command from the voice command, and wherein the sequence of tokens is associated with the custom user-defined command.

12. The computer-implemented method of claim 8, wherein receiving the voice command further comprises detecting that the user has spoken a wake word associated with the appliance.

13. The computer-implemented method of claim 8, the computer-implemented method further comprising:
outputting an auditory confirmation request to the user, wherein the auditory confirmation request prompts the user to confirm the voice command; and
receiving an auditory confirmation from the user, wherein the auditory confirmation confirms the voice command.

14. An appliance with integrated network-independent appliance control functionality using natural language processing and user feedback, comprising:
an appliance interface;
an appliance controller operatively coupled to the appliance interface; and
a communications adapter apparatus communicatively coupled to the appliance controller, wherein the apparatus comprises:
a processor;
a communication interface; and
a memory having executable code stored thereon, wherein the executable code, when executed by the processor, causes the processor to:
receive a voice command to control the appliance from a user;
parse the voice command using a natural language understanding (“NLU”) module;
translate the voice command into a set of tokens, wherein the set of tokens corresponds to a set of interface elements on the appliance interface of the appliance;
transmit the tokens to the appliance controller of the appliance; and
based on the tokens, control the appliance through the appliance controller of the appliance.

15. The appliance of claim 14, wherein the voice command comprises a request to change a configuration of the appliance, wherein parsing the voice command comprises identifying one or more parameters associated with the request to change a configuration of the appliance, and wherein translating the voice command into a set of tokens comprises selecting one or more tokens based on the one or more parameters.

16. The appliance of claim 14, wherein translating the voice command further comprises:
accessing a token database, the token database comprising one or more entries associated with one or more appliances, wherein the one or more entries comprise one or more tokens associated with one or more appliance functions;
identifying a set of entries within the one or more entries, wherein the set of entries are associated with the appliance;
identifying a sequence of tokens associated with the appliance and corresponding to the voice command; and
generating the sequence of tokens based on the one or more entries within the token database.

17. The appliance of claim 16, wherein the voice command comprises a custom user-defined command, wherein parsing the voice command comprises detecting the custom user-defined command from the voice command, and wherein the sequence of tokens is associated with the custom user-defined command.

18. The appliance of claim 14, wherein receiving the voice command further comprises detecting that the user has spoken a wake word associated with the appliance.

19. The appliance of claim 14, wherein the executable code further causes the processor to:
output an auditory confirmation request to the user, wherein the auditory confirmation request prompts the user to confirm the voice command; and
receive an auditory confirmation from the user, wherein the auditory confirmation confirms the voice command.

20. The appliance of claim 14, wherein the executable code further causes the processor to initiate a supervised learning process, the supervised learning process comprising:
prompting the user for feedback regarding a result of controlling the appliance;
receiving, from the user, auditory feedback regarding the result of controlling the appliance; and
based on the auditory feedback, adjust one or more predefined settings associated with the appliance using an artificial intelligence (“AI”) module.
